(19) United States
(12) Patent Application Publication
(10) Pub. No.: US 2007/0082078 A1
(43) Pub. Date: Apr. 12, 2007

(54) Measuring fixture

(75) Inventor: Guido Drees, Lubbecke (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/245,979

(22) Filed: Oct. 6, 2005

(51) Int. Cl. B29C 47/92

(52) U.S. Cl. 425/140

(57) ABSTRACT

A measuring fixture allows the measurement of injection molded parts in a wide range of orientations within the measuring machine. A universal part holding component can be positioned in any of twenty four (24) positions within the measuring fixture as required by the features of the injection molded parts which need to be measured.

### TECHNICAL FIELD

The present invention relates generally to injection molding and deals more particularly with a measuring fixture for measuring plastic parts produced by injection molding.

### BACKGROUND OF THE INVENTION

In the plastic injection molding field, it is necessary to inspect plastic injection molded parts at several stages during the development and production process. In order to be inspected, the plastic injection molded part has to be placed in fixtures to control the correct orientation within the measuring machine. In the past, for each new plastic injection molded part undergoing the development and production process, several measuring fixtures had to be produced to hold the part in different orientations. Accordingly, it would be a great advantage to provide a universal measuring fixture which could hold the injection molded parts in a wide range of orientations within the measuring machine.

### SUMMARY OF THE INVENTION

It is an object of the present invention to provide a novel measuring fixture for measuring injection molded parts.

It is also an object of the present invention to provide a simple and inexpensive means for measuring injection molded parts.

It a further object to provide such an measuring fixture which may be readily and economically fabricated and will enjoy a long life in operation.

It has now been found that the foregoing and related objects can be readily attained in a novel measuring fixture for use in holding an injection molded part in various orientations in a measuring machine. The measuring fixture comprising a base, an upstanding structure mounted on the base for supporting a part holding component in various orientations and a part holding component mounted on the upstanding structure in various orientations and adapted to mount an injection molded part.

Desirably, the measuring fixture has two additional upstanding structures mounted on the base for supporting the part holding component in various orientations. The first upstanding structure is adapted to support the part holding component with the longitudinal axis in a horizontal orientation while the second upstanding structure is adapted to support the part holding component with the longitudinal axis in a vertical orientation and the third upstanding structure is adapted to support the part holding component with the longitudinal axis in a forty five degree angle orientation to horizontal.

According to the invention, each upstanding structure includes at least one recess for mounting the part holding component on the upstanding structure in various orientations. The part holding component has at least one octagonally shaped mounting portion dimensionally sized for insertion in the at least one recess for mounting the part holding component on each upstanding structure in various orientations.

In still other features of the invention, at least a portion of the part holding component is transparent for purposes of backlighting and at least a portion of the upstanding structure is cutout for purposes of illumination of the injection molded part during measurement.

Ideally, the upstanding structure includes retaining devices for temporarily securing the part holding component in assembly with the upstanding structure. These retaining devices for temporarily securing the part holding component in assembly with the upstanding structure can be spring loaded detents.

The invention will be fully understood when reference is made to the following detailed description taken in conjunction with the accompanying drawings.

### BRIEF DESCRIPTION OF THE DRAWINGS

FIG. 1 is a perspective view of a measuring fixture embodying the present invention and showing its universal part holding component in each of three primary locations;

FIG. 2 is a top view of the measuring fixture illustrated in FIG. 1; and

FIG. 3 is a right side view of the measuring fixture illustrated in FIG. 1.

### DETAILED DESCRIPTION OF PREFERRED EMBODIMENTS

Turning now to the drawings and considering the invention in further detail, a measuring fixture is illustrated therein and generally indicated by the reference numeral 10. The measuring fixture is designed for holding injection molded parts 12A, 12B during inspection thereof in a measuring machine (not shown). The measuring fixture 10 has a base 14 which is adapted to be mounted in the measuring machine. Extending upwardly from the base 14 are three mounting devices generally indicated by the reference numerals 16, 18, 20 which permit measuring the injection molded parts 12A, 12B in a range of orientations, e.g., 0°, 45°, 90° and 180°. The injection molded parts can be components for cellular phones such as device covers.

The first mounting device 16 has two spaced apart, equally sized stanchions 30A and 30B with defined angled collar recesses 32 on their inner facing sides. Seated in the angled collar recesses 32 is a universal part holding component 34 for mounting the injection molded parts 12A, 12B on either side using screws (not shown). The universal part holding component 34 has a metal frame 35 with a part specific mounting plate 36 attached thereto by screws 37. The part specific mounting plate 36 is made of transparent polycarbonate plastic to allow application of correct backlighting within the measuring machine. The universal part holding component 34 also has spaced apart octagonal end extensions 38 extending from the ends thereof to permit the universal part holding component 34 to be accurately placed in the angled collar recesses 32 in eight different angled positions by simply lifting the universal part holding component 34 from the angled collar recesses 32, rotating the universal part holding component 34 until the desired position is reached and then reinserting the same into the angled collar recesses 32 until it is seated therein. In each of the eight positions, the longitudinal axis of the universal part holding component 34 is maintained in a horizontal orientation.

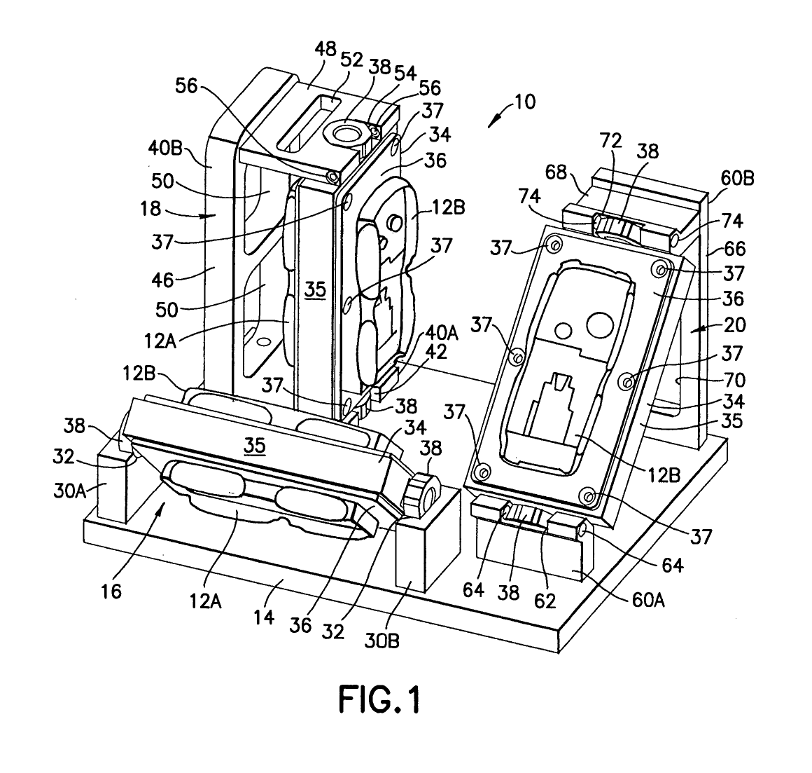

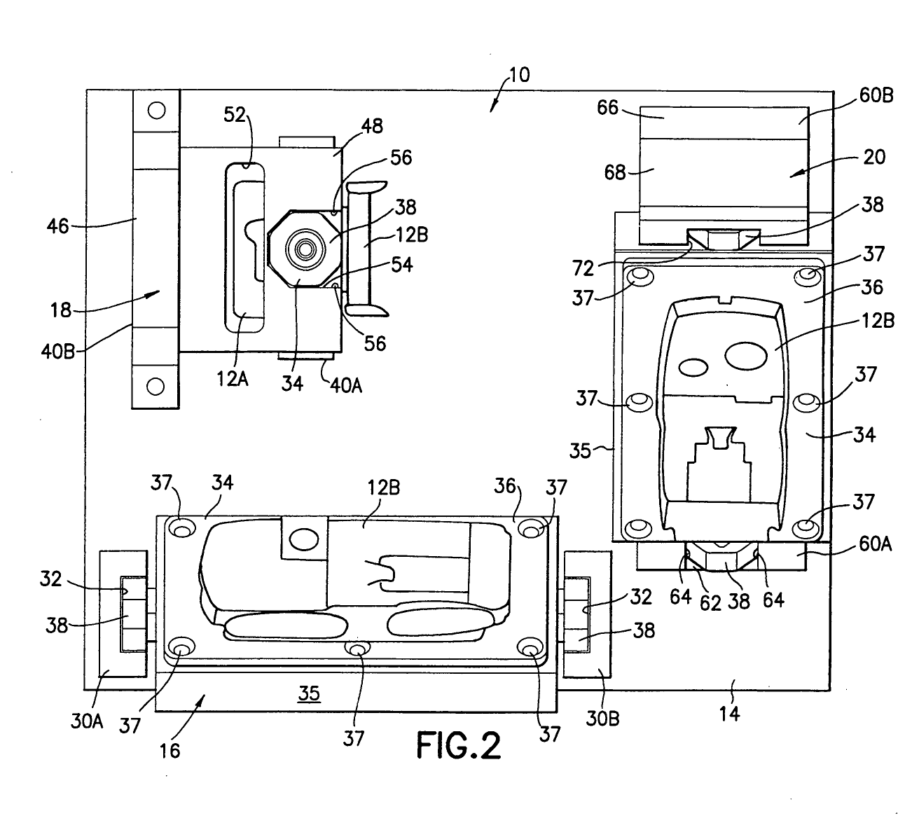

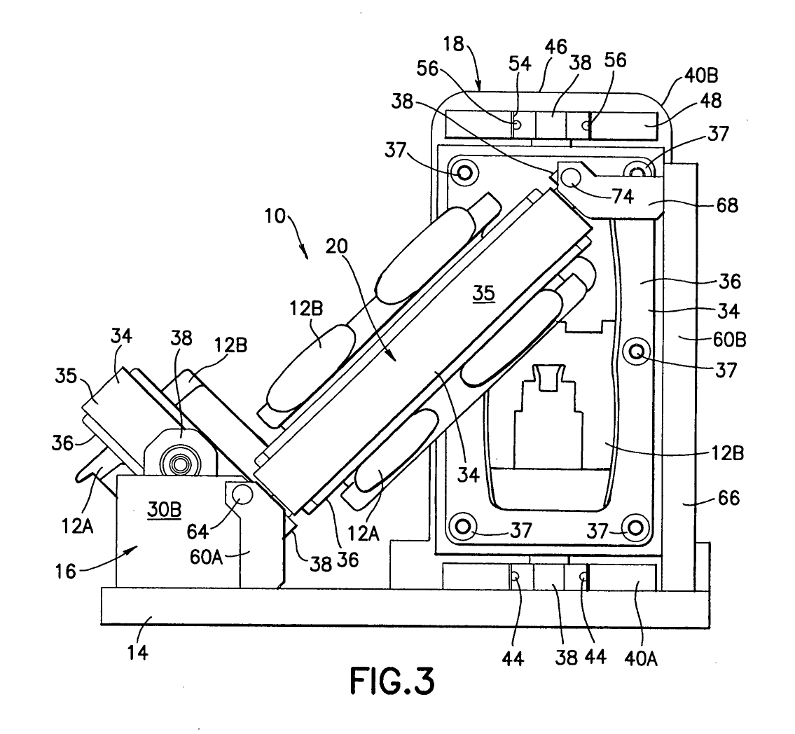

If it is desired to maintain the longitudinal axis of the universal part holding component 34 vertically, the second mounting device 18 can be used. The second mounting device 18 has two stanchions 40A, 40B mounted on the base 14. The stanchion 40A lies on the base 14 and has a generally rectangular form. The stanchion 40A also defines angled U-shaped recess 42 and has a pair of spring loaded detents 44 (FIG. 3) extending into the angled U-shaped recess 42 to removably retain the octagonal end extension 38 of the universal part holding component 34 therein. The stanchion 40B has an upstanding portion 46 spaced from the stanchion 40A and a cantilevered portion 48 extending over the stanchion 40A. The upstanding portion 46 is provided with two cutouts 50 useful for illuminating the injection molded part 12A during measurement. The cantilevered portion 48 not only has a cutout 52 useful for illuminating the injection molded part 12A during measurement but also has an angled U-shaped recess 54 on its outer end with a pair of spring loaded detents 56 (FIGS. 1-3) extending into the angled U-shaped recess 54 to removably retain the octagonal end extension 38 of the universal part holding component 34 therein. The combination of the angled U-shaped recesses 42, 54 and the spaced apart octagonal end extensions 38 permits the user to accurately place the universal part holding component 34 in the angled U-shaped recesses 42, 54 in eight different angled positions by pulling the universal part holding component 34 laterally from the angled U-shaped recesses 42, 54 against the action of the detents 44, 56, rotating the universal part holding component 34 until the desired position is reached and then reinserting the same into the angled U-shaped recesses 42, 54 until it is held by the action of the detents 44, 56.

Using the third mounting device 20, the longitudinal axis of the universal part holding component 34 can be held at a forty five degree (45°) angle. The third mounting device 20 has two stanchions 60A and 60B mounted on the base 14. The stanchion 60A extends upwardly from the base 14 and has forty five degree (45°) angled slot 62 cut therein. A pair of spring loaded detents 64 extend into the slot 62 to removably retain the octagonal end extension 38 of the universal part holding component 34 therein. The stanchion 60B has an upstanding portion 66 spaced from the stanchion 60A and a cantilevered portion 68 extending outwardly toward the stanchion 60A. The upstanding portion 66 is provided with a cutout 70 (FIG. 1) useful for illuminating the injected molded part 12A during measurement. The cantilevered portion 68 is provided with a forty five degree (45°) angled slot 72 with a pair of spring loaded detents 74 extending into the forty five degree (45°) slot 72 to removably retain the octagonal end extension 38 of the universal part holding component 34 therein. The combination of the forty five degree (45°) angled slots 62, 72 and the spaced apart octagonal end extensions 38 permits the user to accurately place the universal part holding component 34 in the third mounting device 20 in eight different angled positions by pulling the universal part holding component 34 from the forty five degree (45°) angled slots 62, 72 against the action of the detents 64, 74, rotating the universal part holding component 34 until the desired position is reached and then reinserting the same into the forty five degree (45°) angled slots 62, 72 until it is seated therein and retained by the detents 64, 74.

While three universal part holding components 34 are illustrated in FIGS. 1-3, it should be understood that only one universal part holding component 34 is required per fixture 10 as it can be moved between the mounting devices 16, 18 and 20 as required.

In use, the measuring fixture 10 allows the measurement of injection molded parts 12A, 12B in a wide range of orientations within the measuring machine. The universal part holding component 34 can be positioned in any of twenty four (24) positions within the measuring fixture 10 as required by the features of the injection molded parts 12A, 12B which need to be measured. The transparency of the part specific mounting plate 36 allows the application of the correct backlighting within the measuring machine. Accordingly, the present invention provides an advantage over the prior art by making the measuring process easier. A further advantage is realized from the reduced manufacturing cost since the measuring fixture 10 can be universal and reusable for all different types of injection molded parts as only the part specific mounting plate 36 need be replaced for each project.

The preferred embodiment described above admirably achieves the objects of the invention. However, it will be appreciated that departures can be made by those skilled in the art without departing from the spirit and scope of the invention which is limited only the following claims.

What is claimed is:

1. A measuring fixture for use in holding an injection molded part in various orientations in a measuring machine, the measuring fixture comprising:
a base;
an upstanding structure mounted on the base for supporting a part holding component in various orientations; and
a part holding component mounted on the upstanding structure in various orientations and adapted to mount an injection molded part.

2. The measuring fixture as defined in claim 1, further including another upstanding structure mounted on the base for supporting the part holding component in various orientations.

3. The measuring fixture as defined in claim 2, wherein the part holding component has a longitudinal axis and one upstanding structure is adapted to support the part holding component with the longitudinal axis in a vertical orientation while the other upstanding structure is adapted to support the part holding component with the longitudinal axis in a horizontal orientation.

4. The measuring fixture as defined in claim 2, wherein the part holding component has a longitudinal axis and one upstanding structure is adapted to support the part holding component with the longitudinal axis in a vertical orientation while the other upstanding structure is adapted to support the part holding component with the longitudinal axis in a forty five degree angle orientation to horizontal.

5. The measuring fixture as defined in claim 2, wherein the part holding component has a longitudinal axis and one upstanding structure is adapted to support the part holding component with the longitudinal axis in a horizontal orientation while the other upstanding structure is adapted to support the part holding component with the longitudinal axis in a forty five degree angle orientation to horizontal.

6. The measuring fixture as defined in claim 2, further including a third upstanding structure mounted on the base for supporting the part holding component in various orientations.

7. The measuring fixture as defined in claim 1, wherein the upstanding structure includes at least one recess for mounting the part holding component on the upstanding structure in various orientations.

8. The measuring fixture as defined in claim 7, wherein the part holding component has at least one octagonally shaped mounting portion dimensionally sized for insertion in the at least one recess for mounting the part holding component on the upstanding structure in various orientations.

9. The measuring fixture as defined in claim 1, wherein at least a portion of the part holding component is transparent for purposes of backlighting.

10. The measuring fixture as defined in claim 1, wherein at least a portion of the upstanding structure is cutout for purposes of illumination of the injection molded part.

11. The measuring fixture as defined in claim 1, wherein the upstanding structure includes retaining devices for temporarily securing the part holding component in assembly with the upstanding structure.

12. The measuring fixture as defined in claim 11, wherein the retaining devices for temporarily securing the part holding component in assembly with the upstanding structure are spring loaded detents.

13. The measuring fixture as defined in claim 1, wherein the injection molded part to be measured is a component for a cellular phone.

14. The measuring fixture as defined in claim 13, wherein the component is a device cover.
